(19) United States
(12) Patent Application Publication
(10) Pub. No.: US 2004/0193438 A1
(43) Pub. Date: Sep. 30, 2004

(54) Merchandise return system with value added returns processing (dispositioning)

(76) Inventors: Edward J. Stashluk JR., Austin, TX (US); Michael J. Stevens, Austin, TX (US); Jennifer A. Milch, Austin, TX (US); Phillip J. Sidari, Austin, TX (US); Terry Combs, Cedar Park, TX (US); Douglas J. Kern, Austin, TX (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/744,287

(22) Filed: Dec. 23, 2003

Related U.S. Application Data
(60) Provisional application No. 60/446,142, filed on Feb. 10, 2003.

(51) Int. Cl. G06F 17/60

(52) U.S. Cl. 705/1

(57) ABSTRACT

A method that facilitates customer returns of merchandise. The method makes use of a distributed system of returns centers. Customer returns are made using machine readable return labels. The labels are addressed so that they are initially shipped to a returns center closest to the customer, thereby enabling “reverse zone skipping”. The labels also identify the package, such as by invoice number. Once a package is received at the returns center, the label is scanned into a processing system that also stores various returns “rules”, including rules for dispositioning returns.

### RELATED PATENT APPLICATION

This application claims the benefit of U.S. Provisional Application Serial No. 60/446,142 filed Feb. 10, 2003 and entitled “Retail Package Returns Service System Using Postage Due Labels”.

### TECHNICAL FIELD OF THE INVENTION

This invention relates to merchandise return methods and systems, and more particularly to a method of managing returns of goods purchased from retailers and other merchants.

### BACKGROUND OF THE INVENTION

The typical returns process for most direct retailers, includes providing a static return label on the order summary where the customer pays out-of-pocket and finds a shipper to start the return process. Customers who uses this type of return system have been shown to have lower satisfaction with the returns process than other key customer service areas. The process suffers from lack of visibility because the merchant does not receive advance notification of in-transit returns. As a result, customer service and warehouse receiving does not have visibility into the flow of returns track packages or deliver early customer notifications. The process further suffers from inefficient transportation load-balancing. Shipments are not load-balanced by warehouse by the carrier, forcing additional intra-warehouse transportation and processing.

The growing use of electronic commerce as a customer marketplace has led to a greater need for appropriate customer return methods. In the absence of conveniently located retail stores, the customer needs an acceptable method of returning goods. Various “reverse logistics” systems have been developed to meet this need. These systems are a subset of the growing industry of “supply chain management” systems, and are designed to help merchants manage customer returns.

For returns, as opposed to forward deliveries, the typical returns process requires the customer to take the package to the carrier and pay shipping costs. As an alternative to customer-paid shipping, some merchants have turned to a merchandise return service available from the United States Postal Service (USPS), which permits the customer use an addressed and prepaid merchandise return label. The customer may deposit the package at any post office or in a mailbox, and postage is paid by the merchant. The merchant decides the ultimate return shipping cost to the customer, such as by deducting that cost from the customer's credit.

Existing merchandise return service methods, such as that offered by the USPS, although convenient for the customer, can be costly and time consuming for the merchant.

It is not enough to provide customers exceptional service in getting packages out the door and into the home. Today, retailers must provide an exceptional returns service. The reward is loyal, better and more profitable customers. The risk of a poor returns experience is alienating an entire generation of direct shoppers who then lose confidence in the brand itself and in the direct purchasing process in general.

For most retailers, returns management is an afterthought. Instead of proactively addressing return-related issues starting with the original order, many retailers wait until the return package has arrived in the warehouse. This creates uncertainty on the part of the customer and inefficient operations inside the warehouse. The average retailer provides a basic level of information about how to return a product on the outbound order summary. In most cases this includes a set of return instructions and an address to which the return package must be mailed. The customer must package the return and find a convenient location to purchase return postage (US Post Office or another shipper). Once the return package is received by the retailer (typically 5-10 days later), it normally takes an additional 3-4 days for the return to be processed. During this time, the customer has little, if any, insight into what is happening with her return. To insure that the credit has been processed, the customer must wait 2-3 billing cycles to see it appear on her credit card statement or she must contact the retailer's customer service department. Typically, retailers do little to leverage or exploit return reason codes, and seldom do they integrate marketing or loyalty programs within the returns process.

### BRIEF DESCRIPTION OF THE DRAWINGS

FIG. 1 illustrates a merchandise return process using postage due return labels in accordance with the invention.

FIG. 2 illustrates a return label in accordance with the invention.

FIG. 3 illustrates an example of bar code fields for the bar code of FIG. 2.

FIG. 4 illustrates a method of generating a return label in accordance with the invention.

FIG. 5 illustrates the use of the return label by the customer.

FIG. 6 illustrates the use of the return label at the return center for issuing customer credit.

FIG. 7 illustrates a process of dynamic routing, using data on the return label.

FIG. 8 illustrates one embodiment of a method of handling returns at a value added returns center, such as the returns center of FIG. 1.

### SUMMARY OF THE INVENTION

One aspect of the invention is that it provides comprehensive returns management, which starts at the original order, includes the customer initiation of the return, processing and transportation through to final disposition, and spans the physical and informational flows throughout the process. The returns program can result in improved customer experience, new revenue opportunities, reduced operating expenses, and reduced return cycle times. The invention provides an integrated returns management system, which drives the process from the initial customer return through the final disposition of the good.

The returns process impacts two main areas of a merchant's return operations: the impact on call center volume and savings from load-balancing inbound returns shipments. Call center savings are impacted through a more convenient returns process, returns tracking and earlier customer notifications (both email and postcard). Reducing return-related calls to call centers will provide substantial savings. Load-balancing savings is realized through reduced transportation expense and reduced processing expenses.

A particular advantage of the dispositioning aspects of the invention is that dispositioning occurs as close to the customer as possible, reducing unnecessary shipping and processing expenses and improving asset recovery rates. In addition to lowering shipping expenses, early dispositioning enables faster credit notifications since the return item(s) can be identified. For returns that are return-to-stock, efficiencies increase when returns are placed in front of existing inventory, rather than behind.

### DETAILED DESCRIPTION OF THE INVENTION

This invention described herein is a merchandising method and system that permits a merchant to provide pre-authorized returns, for which the customer need not pay shipping charges. The merchant provides a special return label to the customer, which has machine readable data that enables shipping charges to be assessed at a point of delivery. Data on the return label may further ensure that the package is delivered to an initial point of return close to the customer, thereby providing “reverse zone skipping”. The return label may further have data that permits the merchant to dynamically route returned packages and that permits both the merchant and the customer to be quickly notified of the status of the return.

Once a package is received at a returns center, the label is scanned, or otherwise electronically read, and compared to stored data that includes various “rules” associated with each merchant. A processing system is used to link each return package to its associated rules, and to provide various value added services, such as notice to the merchant and/or the customer and dispositioning of the item.

The method is used by, or on behalf of, a “merchant”, which is typically a retail merchant. However, the concepts discussed herein may be applied to any merchant, including service providers who sell goods incidentally to the providing of services. The “return” may be for purposes of receiving credit for an item recently purchased, but may also be subsequent to events such as warranty claims, recalls, or for repairs.

The method described herein may be used in connection with a “reverse logistics return service”. This type of service is becoming increasingly popular, and permits merchants to “outsource” their returns process. For purposes of this description, these service providers are referred to as “returns providers”. They typically provide returns services for a number of different merchants, with part of their services being disposing of packages in accordance with the particular disposition rules of each merchant.

If the merchant uses such a returns provider, the returns label will further have data useful for identifying each merchant and may contain other data particular to that merchant. However, the methods described herein are also useful for returns systems that handle only returns for a single merchant, such as for a merchant having an in-house returns provider.

One example of a returns service that could incorporate use of the return label described herein is the SmartLabel™ service offered by Newgistics, Inc. This service makes use of a bar-coded shipping label, typically attached to an invoice received by the customer when the product is delivered to the customer. To return the product, the customer simply affixes the label to the return package, and drops the package anywhere into the U.S. Postal System (USPS), such as by dropping it into a mailbox. The label directs the package to a returns center maintained by the service provider. The returns provider assesses shipping charges, pays the carrier, and passes the shipping costs on to the merchant, who may then deduct those costs from the customer's credit for the returned item. The various services that the returns provider provides to the merchant include the return label, aggregation of packages to each merchant, transportation and processing services, payment of shipping charges, reporting, and notifications to the merchant and/or the customer.

For purposes of example herein, it is assumed that the carrier that ships the returned items is the United States Postal Service. However, the same concepts could be applied to a returns process that uses other carriers or multiple carriers, so long as each carrier has the equivalent of postage due capability, that is, the ability to collect shipping charges after the package is delivered, that is, from the returns provider (the package recipient) rather than from the customer.

Overview of Returns with Postage Due Shipping

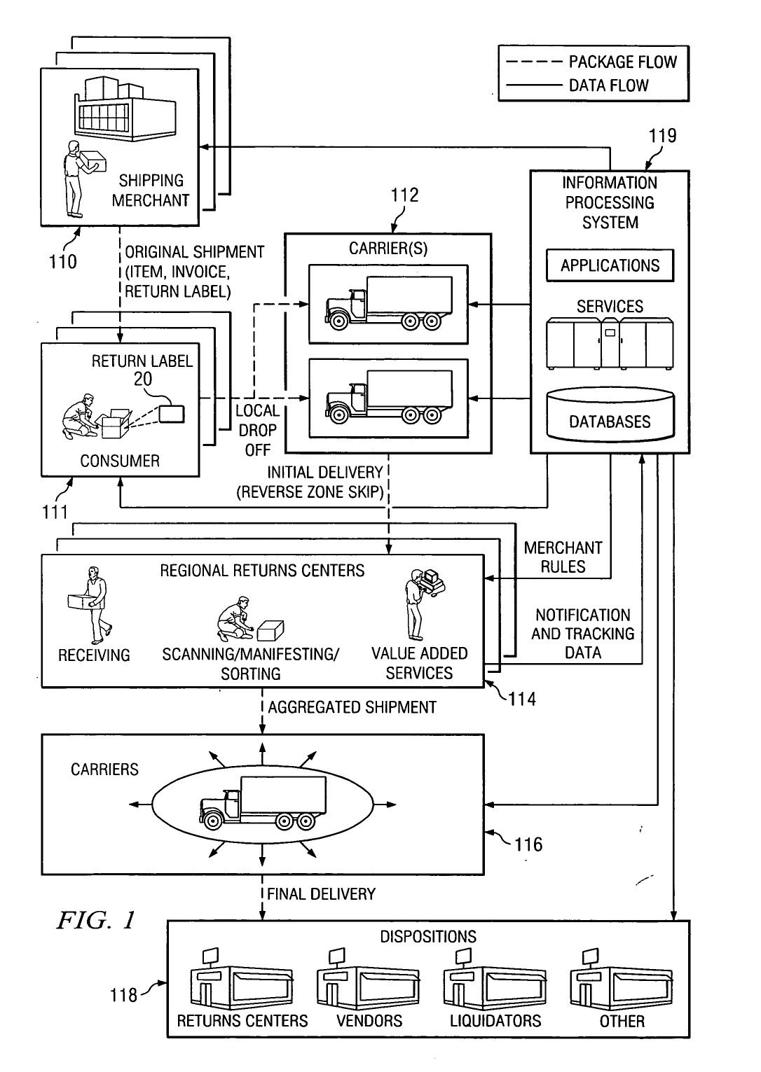

FIG. 1 illustrates a returns process that uses postage due return labels in accordance with the invention. In the embodiment of FIG. 1, returns are processed through a returns provider that handles returns for multiple merchants. However, as stated above, the method described herein may be easily adapted for a returns provider that handles only returns for a single merchant. In either case, the merchant is considered to “maintain” at least one returns center, whether by directly maintaining the returns center(s) or by associating with a third party that does so.

In Step 110, a merchant has delivered an item to a customer. In Step 111, the customer has decided to return the item, herein referred to as “the return item”.

A returns label 20 has already been, or is to be, provided to the customer. In the example of FIG. 1, the return label 20 is delivered as an enclosure with the customer's original order, such as by being part of the customer invoice or a separate insert.

In other embodiments, return label 20 could be downloaded from a data network and printed by the customer, or otherwise delivered to the customer by means other than being included with the merchandise delivery. For example, the return label 20 could be separately mailed or send as by facsimile. As another example, the customer might access a website provided by the merchant, link to a returns page, and download the data for printing the return label.

Return label 20 is “pre-authorized” in the sense that the customer need not seek authorization from the merchant. The customer is apprised by the merchant that returns are pre-authorized, such as by information on the invoice or other shipping documents. The notification may be explicit on the return label or elsewhere or may be implicit. The customer is further apprised that the customer need not pay shipping charges, such as by a “no postage necessary” printing on the return label 20.

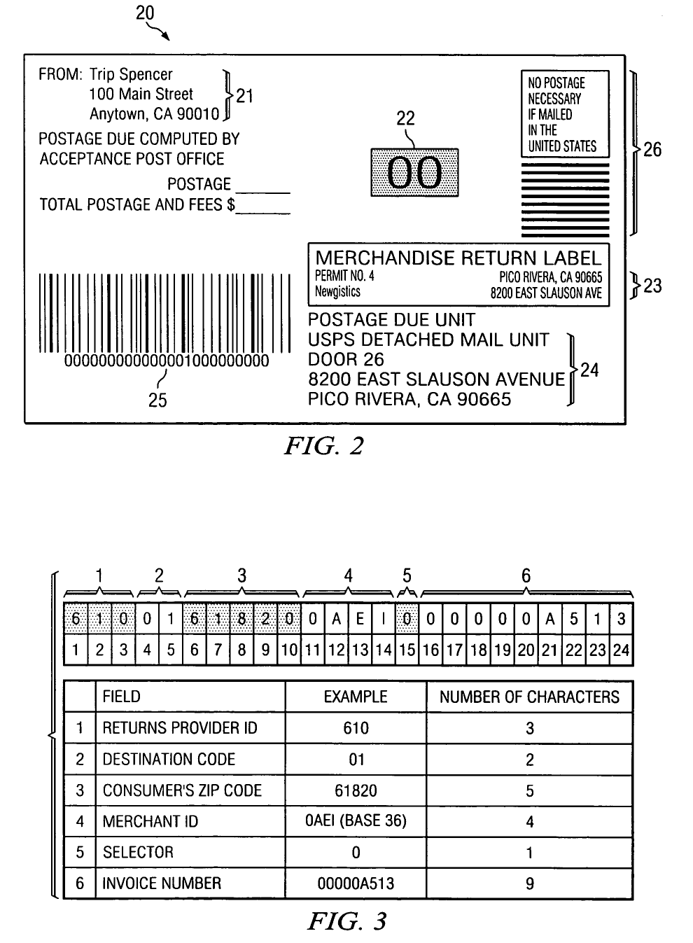

An example of a suitable return label 20 is described below in connection with FIGS. 2 and 3.

The customer affixes the returns label 20 to the packaging for the return item, and hands over the return item to a carrier, without paying any shipping charges to the carrier. The customer need not affix any indicia of postage or other shipping costs to the packaging. In the example of this description, the customer may simply deposit the package into the US postal system, by putting it into a mailbox (if postal compliant), dropping it off at a postal drop, or taking it to a post office. The return is local to the customer in the sense that the customer may select whatever drop-off point is most convenient.

As further explained below in connection with FIG. 2, return label 20 is preprinted to indicate at least the destination for the item and the package origin (the point where the customer places the package with a carrier). Typically, the destination and origin are identified by addresses, including postal codes. For purposes of this description, “postal codes” include the ZIP (zone improvement plan) codes of the USPS and similar codes used in other countries.

The returns label further indicates that delivery charges are to be paid by a recipient. It further identifies the transaction leading to the return. Typically, this is a purchase transaction and the identification is by invoice number or other indicia of the package or its contents. In other embodiments, the transaction could be a warranty claim or repair request.

In Step 112, the carrier delivers the return item to the returns provider. As stated above, in the embodiment of FIG. 1, the initial point of return for the package is a specialized returns center, which may receive returns for more than one merchant. The returns center may be regional for a large area such as the United States. In other words, a large geographic area may have a number of returns centers.

For a returns provider having regional returns centers, the return label 20 may ensure “reverse zone skipping”. At the time the data for each returns label 20 is composed, the destination address on the label 20 is determined.

The destination address is typically that of a carrier station (such as a postal center) nearest the customer. This may mean that return packages are carried from the customer drop-off location to a destination associated with the carrier for pickup by the returns provider. For example, where the carrier is the USPS, the package could be delivered to one of 21 regional bulk mail centers (BMCs). The package is delivered to the BMC closest to the location of the returns provider. The returns provider may then pick up accumulated packages addressed to it. Equivalently, the carrier then may deliver the package directly to the returns center. In either case, the destination address is considered to be “to” a returns center closest to the customer.

In Step 114, the returns provider receives the package from the carrier. The returns provider scans the return label on the package and weighs the package. Any special shipping flags or indicia are entered at this time. In this manner, the returns provider receives multiple packages, which may be items originating from multiple merchants, throughout a daily course of business.

In a process known as “manifesting”, the returns provider calculates the shipping charges due to the carrier and electronically manifests the carrier. Typically, this is done on a daily basis. In the example of this description, the returns provider pays the carrier, and is compensated by the merchant for carrier costs and other services.

The returns provider then sorts the packages by merchant, again using data printed on return label 20, and collects the packages associated with each merchant. The final destination code is encoded on the return label, and may also be printed in human readable form. For large volume merchants, the destination code may be associated with a package chute and/or a docking door.

The returns provider may also provide “value added” services for the benefit of the merchant, such as notification of the return to merchant or notification to the customer of receipt of the package. For example, the returns provider may use the scanned return label information to notify the customer and/or the merchant that the package has been received.

In Step 116, after aggregating the packages for each merchant, the returns provider further ships them in accordance with whatever policies are specified for that merchant. For example, the returns provider may palletize shipments back to the merchant. The return label data is used to create a bill of lading, with data such as pallet counts, package counts, and shipment weight.

In Step 118, the package is handled according to the disposition policy of the merchant, such as by being returned to stock, sent to a re-seller, liquidator, or otherwise disposed.

A processing center 119 is used to collect data scanned from return labels, and to process the returns. The processing center 119 includes computer processing equipment, including computers, data storage, and networking equipment, appropriate for communication of data to and from returns centers, merchants, and customer, as appropriate.

The computing equipment is programmed to fulfill the various data processing services described herein. For example, processing center 119 may provide a web page or other network-accessible data source, accessible by customers for obtaining information about returns and data for printing return labels. It also stores business rules from merchants, which are typically delivered to it by electronic transmission over a data communications network. As explained below, the processing center 119 match data on the return label to these merchant rules, which may specify disposition of the package or other rules for handling the return.

Returns Label Provided to the Customer

FIG. 2 illustrates an example of a return label 20, suitable for use with the merchandise return method of FIG. 1. In the example of FIG. 2, the carrier is the USPS. Return label 20 incorporates data appropriate for the merchandise return service offered by the USPS, as well as data used for additional services provided by the returns provider. As stated above, other or additional carriers having the equivalent of postage due capabilities could be used, in which case, return label 20 would be modified to comply with the requirements of those carriers.

The customer's address 21 is printed on the upper left corner of label 20. This address matches the original delivery address.

The visual flag 22 is a human readable code, that can be used for various purposes. In the example of this description, flag 22 is a destination code that indicates a final package destination. Examples of final destinations are a merchant's warehouse, a liquidator, or a warranty, recall or repair center. This destination code may match a destination code embedded in barcode 25. In other embodiments, flag 22 could correlate to any sort of business “rule” of a merchant. As another example, visual flag 22 could indicate a quality of service, such as whether the package is to expedited or held for some reason. Or flag 22, could indicate the contents of the package, such as whether it is “high value” for special handling.

In general, flag 22 permits the package to be manually sorted at the returns center for subsequent routing. The examples set out above for its use are merchant-specific, in the sense that the flag is specific to a particular merchant and its returns processing rules. The flag, being human readable, can be easily correlated to rules displayed on a display in communication with processing system 119. These displays can be conveniently located at stations at the returns center and the displayed information used for sorting and other handling decisions.

The merchandise return rectangle 23 is specific to the carrier and pertains to the relationship between the carrier and the returns provider. In the example of this description, it states the USPS permit information of the returns provider.

The delivery address 24 is, as explained above, the address of a delivery location that is geographically nearest the customer. This determination of this address is dependent on the customer's postal code, as specified during the transaction leading to the return (such as the purchase transaction). As stated above, the delivery address could be a carrier center, such as a USPS bulk mail center, where it is held for pickup by the returns provider.

Barcode 25 is a dynamically generated machine-readable code that is based on unique information about the specific transaction involving the item(s) being returned. An example of barcode data is described below, but in general, the barcode data provides data for information servers 119 so that various “value added” returns processing tasks may be performed, such as manifesting of shipping charges, notifications to the customer and/or merchant, and final disposition of the returned item.

The barcode data permits the returns center to correlate the returned item back to the transaction with the customer. One type of correlation is an invoice number, as indicated by the example below.

Barcode 25 may comprise various alphanumeric or numeric only formats. Various other types of machine readable coding could be used as an alternative to bar-coding, such as other types of optical scan data or radio frequency identification (RFID) tagging. The coding may be printed or may be some other format, such as the electronic circuitry used in an RFID tag.

The “postage due” insignia 26, including the horizontal bars 26a, indicates to the customer and the carrier that shipping charges are to be paid by the recipient.

Barcode 25 is a “third party barcode” in the sense that need not be specified by the carrier, which in this case, is the USPS. Although not shown in FIG. 2, return label 20 may have one or more additional barcodes, for example a barcode containing data for the carrier's use, such as for carrier tracking or return confirmation.

FIG. 3 illustrates a data string that is an example of the contents of the barcode 25 of FIG. 2. The example of FIG. 3 has 24 positions, each with an alphanumeric character. The information in barcode 25 is “integrated” in the sense that it is contained in a single barcode or other machine readable string of data. Information in other machine readable coding may be integrated in a similar manner.

The barcode 25 contains multiple data points, and contains data that is “transaction specific”, in the sense that it identifies the transaction between the customer and the merchant or other party to whom the package is being delivered. The “transaction specific” data is dynamically generated in the sense that it is generated after the original order is made, and is specific to that transaction.

In general, the barcode data points are used to process the package for purposes other than moving it from one place to another. In contrast, “carrier specific” data elsewhere on the label 20 functions merely for shipping purposes.

Field 1 identifies the returns provider. Field 2 identifies the package destination.

Field 3 represents the shipping origin of the package (customer's postal code), which permits assessment of shipping charges from where the customer drops off the package (the return package origin) to the returns center (or a nearby BMC) where it is pulled from the carrier.

Field 4 identifies the merchant from whom the item was purchased. Or, as explained above, some party other than the merchant may be involved in the transaction leading to the return, such as a warranty or repair service.

Field 5, a selector field, may be used for various purposes, such as to identify the label type, or to identify a shipping category, such as Priority Mail or customer-paid.

Field 6 identifies the transaction involving the returned item in some manner. This is typically the purchase transaction, such as in the case of a customer returning recently purchased goods. This terminology is used herein for sake of consistency. This field is used to correlate the return label to the original order, such as by filling the field with the invoice number. This field could also be used for data such as a customer number, product number (such as an SKU), or other data.

As explained below, data on barcode 25 may be used to correlated the package (or the item inside) to merchant business rules. This involves identifying the merchant or the specific purchase transaction. Any date that permits such identification, whether explicitly or inferentially, may be sufficient for correlation of business rules.

If desired, one or more of the above-described fields could be omitted and another field used to link to the same information at the returns center. For example, Field 3 (the customer's postal code) could be omitted and Field 6 used at the returns center to dynamically link to stored data that provides the customer's postal code. In this event, barcode 25 would equivalently be considered to contain “data representing at least the origin of the package and identification of the transaction”.

It should be understood that the barcode data in the example of FIG. 3 is minimal and additional data could be easily included. Additional data points that may be included in the barcode 25 include data points falling into categories “transaction specific”, “merchant specific”, “customer specific”, “product specific”, “trading partner”, or “disposition” data. “Transaction specific” data identifies the transaction, such as by invoice number in the case of a purchase transaction. The “merchant specific” data identifies the merchant or some characteristic of the merchant. The “customer specific” identifies the customer or some characteristic of the customer. “Product specific” data identifies the package contents, such as by SKU number. “Trading partner” data describes a trading partner of the returns center, such as a liquidator or other service provider. “Disposition” data describes a disposition rule or final destination of the returned item.

Often, the merchant directly provides the return label (or data for generating the return label) to the customer. To this end, the returns provider provides the label specifications to the merchant, as well as a delivery address data file. This data file is used to correlate each customer's postal code to the returns provider location that is closest to the customer. The data file is made available to the merchant via data network access, such as by the internet.

In the example of FIGS. 2 and 3, the data on the returns label 20 is pre-printed. In other embodiments, the customer might fill in at least some of this data. For example, label 20 could have a predetermined format, and the customer would be directed to fill in certain information such as the customer's address, the package invoice number, or a shipping destination. However, in general, regardless whether label 20 is entirely pre-printed or all or partly filled by the customer, it is deemed to have a predetermined format, and prior to being shipped by the customer, to contain certain customer data as discussed in connection with FIGS. 2 and 3.

The various data elements described above in connection with FIGS. 2 and 3 can be used to implement the various returns services described herein, and some of these concepts may be implemented independently of others. For example, by using data representing the origin of the package (such as the customer's postal code), the returns center can perform reverse manifesting. By using data representing the original shipment (such as the identity of the merchant, the invoice, or the item), the returns center can dynamically route the package or notify the merchant or the customer about the status of the return.

Use of the Return Label

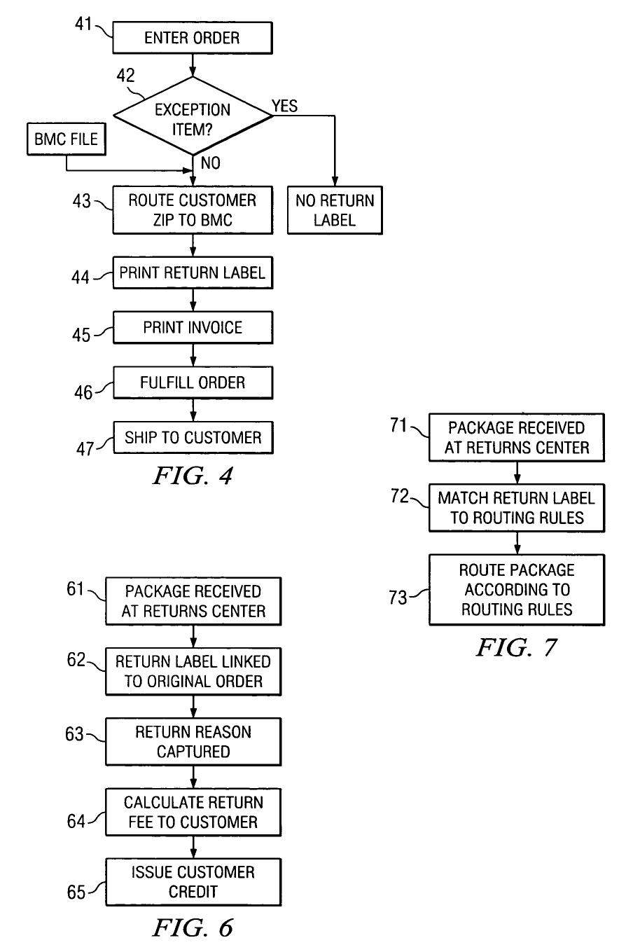

FIG. 4 illustrates a process of generating a return label, such as return label 20. In the example of FIG. 4, the return label 20 is to be provided to the customer in the original shipment. In Step 41, the merchant enters the order information into an automated order processing system. In Step 42, the merchant determines whether the order is an exception item. In Step 43, the merchant receives BMC (bulk mail center) data, which as explained above, is used to determine the BMC closest to the customer. In other embodiments, where the carrier is not the USPS, the address of some other carrier station close to the customer is used. In Steps 44 and 45, the return label and invoice are printed. In Steps 46 and 47, the order is fulfilled and shipped to the customer, with the return label being enclosed with the order.

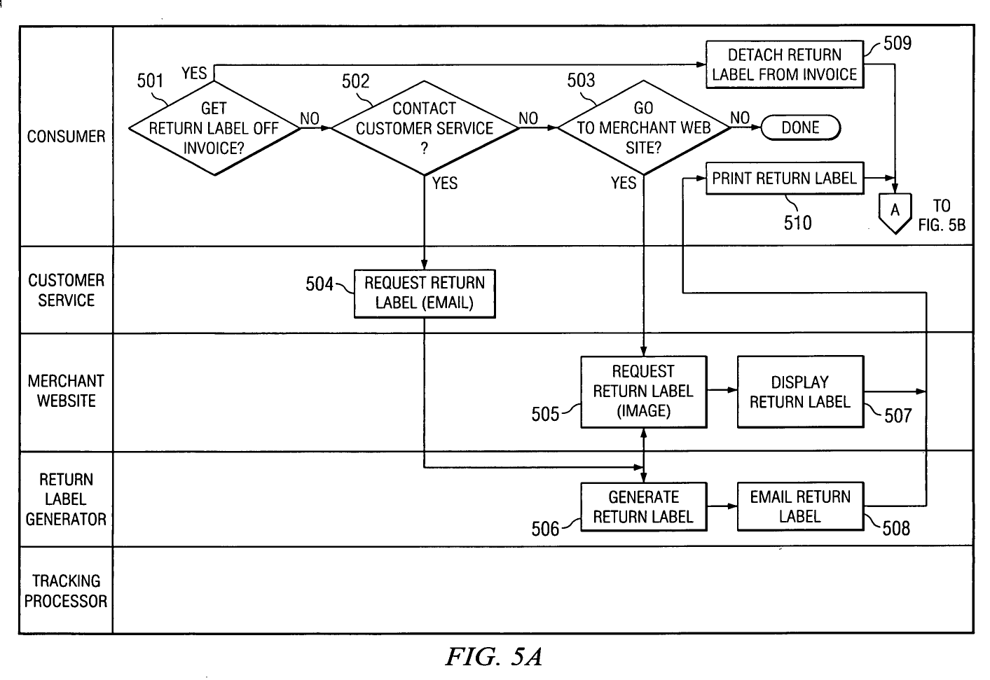

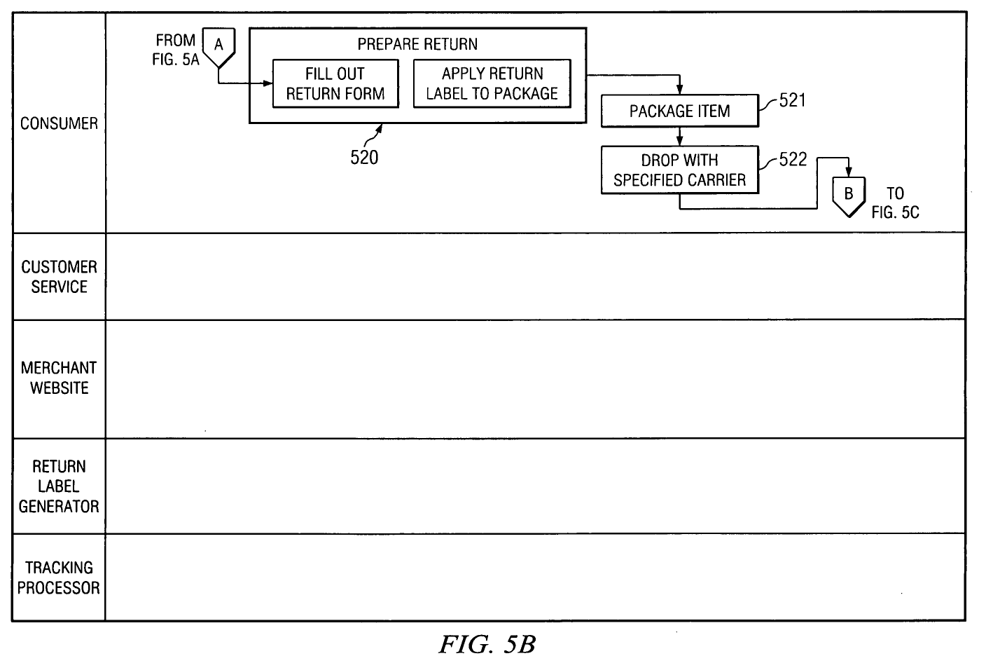

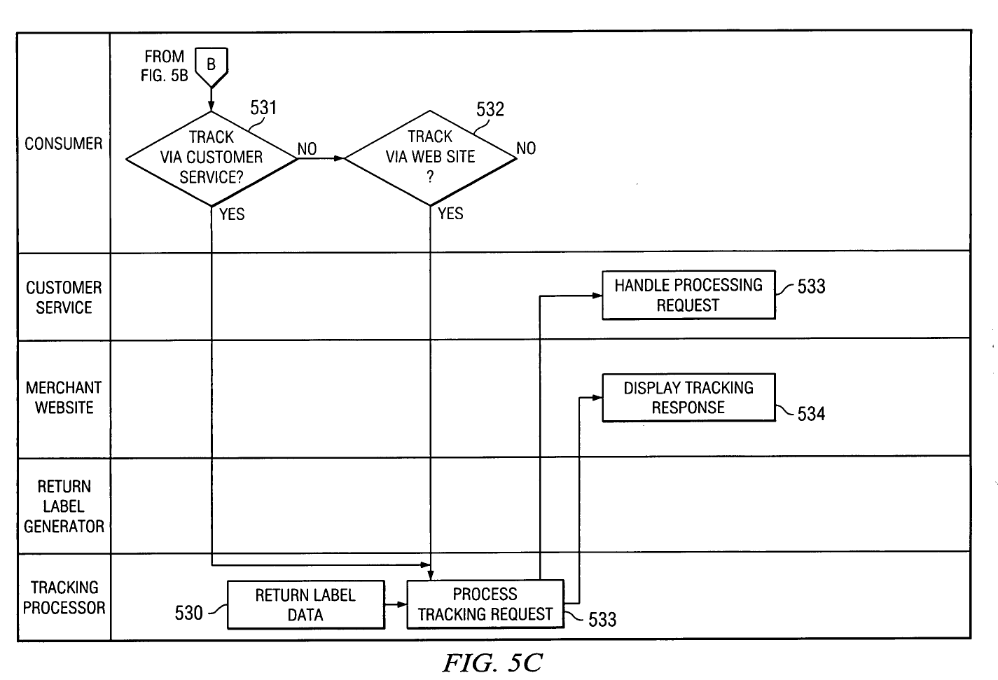

FIG. 5 illustrates the use of the return label 20 by the customer. Steps 501-510 illustrates various alternative ways for the customer to obtain the label 20. It should be understood from FIGS. 4 and 5, that there are various alternative computer-based processes for generating return label 20. Specifically, the label may be generated by the merchant or a returns provider to be included with shipment of an item to the customer. Or, the label may be delivered in electronic form, such as by being downloaded, emailed, or faxed, such that the customer performs the printing.

In Step 501, the customer receives the label 20 with the invoice in the original shipment, as described above in connection with FIG. 4. The customer may merely detach the label (Step 509).

In Step 502, the customer receives the label 20 by contacting customer service of the merchant, such as by phone call or email (Step 504). The label is then generated (Step 506) and emailed to the customer (Step 508).

In Steps 503 and 505, the customer receives the label by accessing a website and requesting an image. The label is generated and displayed (Steps 506 and 507) and the customer prints the label (Step 510).

In Step 520, the customer prepares the return by filling out a return form and applying the return label to the package. In Steps 521 and 522, the customer packages the return and drops it with the carrier specified by the merchant.

Steps 530-536 illustrate how data from the return label can be used to facilitate tracking requests. In Step 530, the package has been received at the returns center and scanned as described above in connection with FIG. 1. The data is stored and accessible by a tracking process, which may be part of processing system 119.

In Step 531, the customer makes a tracking request through customer service of the merchant. In Step 533, the request is processed, and the results communicated to the customer. In Step 532, the customer makes a tracking request via the merchant's website. In Steps 533 and 534, the request is processed and the results are displayed.

FIG. 6 illustrates an example of the use of return label 20 for issuing credit to the customer. FIG. 6 is an expansion of one aspect of the returns center processing in Step 114 of FIG. 1.

In Step 61, the package with the return label affixed is received at the returns center. It is assumed that return label 20 has at least some means to correlate the package to the original order, such as an invoice number. In Step 62, the label is scanned and linked to the original order. In Step 63, the reason for the return is captured, such as by reading the return form. The reason for the return may be used to determine whether the customer is to bear shipping costs for the return, and hence the amount of credit to the customer. The return reason may be communicated to the merchant, in addition to other return information, using processing system 119. In Step 64, the credit due the customer is calculated. Step 64 may involve accessing stored business rules of the merchant. In Step 65, data for implementing credit to the customer is delivered to the appropriate processing center.

Value Added Returns Centers

FIG. 7 illustrates how the data on returns label 20 can be used to implement “dynamic routing”. In Step 71, the package is received at a returns center. In Step 72, at the returns center, using processing system 119, data on barcode 25 is linked to the merchant's specifications for routing the package to its final destination. In Step 73, the package is routed in accordance with whatever specifications are current at that time. For example, the original shipment data may indicate that a package contains a seasonal item. At the end of the season, these packages may then be routed to an outlet destination rather than a re-stock destination. As another example, for a returns center that handles packages for more than one merchant, the original shipment information might merely identify the merchant. The returns center can then match the packages of that merchant to the current rules for that merchant, such as by routing all packages to a particular destination.

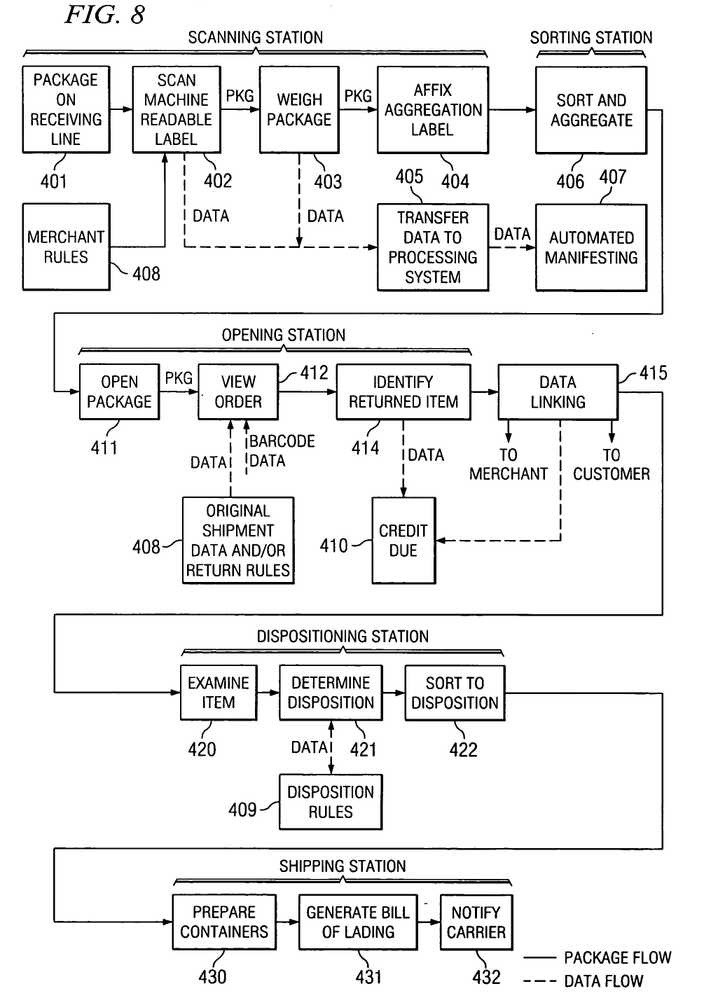

FIG. 8 is an expanded illustration of the services provided at a returns center, Step 114 of FIG. 1. Both the path of packages as they physically move through the return center and the data path of data pertaining the packages are shown. The movement of packages through the return center can be by conveyor belt or any other convenient means. The data path may be achieved by conventional computer networking software and equipment, implemented with processing system 119.

At the returns center many different services can be provided for the benefit of the merchant, so that the merchant's costs from customer returns are minimized and customer satisfaction enhanced. As explained below, these services include notification of the return to the merchant and/or the customer, item level sorting, and item disposition. These services are “rules-based”, which means that the merchant provides rules that are stored in processing system 119, which uses machine readable return information from the package to associate the item with the appropriate rule(s). Processing system 119 is used to store the machine readable data so that it may be displayed at any one or more of the various returns processing stations described below.

In actual implementation, the returns system is best implemented with a number of returns centers, distributed throughout a geographic region such as the United States. Among other advantages, the use of distributed returns centers decreases shipping costs by permitting “reverse zone skipping”. This means that packages are initially delivered to a returns center closest to the customer. From the returns center, packages to common destinations are aggregated and shipped to its final destination. The result is a shipping process that is more expeditious than if each package were required to be shipped all the way from the customer to its final destination.

Steps 401-404 are performed at a scan station by a scan station operator. In Step 401, the incoming package is placed on a receiving line. In Step 402, the machine readable code on the package label is scanned. In Step 403, the package is weighed and the weight recorded. In Step 404, the operator places a label on the package indicating how the package is to be aggregated with other packages, such as by merchant, quality of service, or disposition. This label is for internal use at the returns center and can be machine readable, human readable, or both. In Step 405, the data collected at the scan station is transferred to processing system 119, which creates and stores a data file for the package.

Step 406 is performed at a sorting station, where a sorter identifies the package destination and places the package in a container for packages similarly aggregated. Depending on the returns rules for the merchant, items can be categorized by product category or disposition.

Step 407 is a manifesting step, performed by processing system 119, based on data acquired from reading return label 20 and the weight data. Package level data files are used to generate a manifesting report representing shipping charges for all packages received in a batch. Typically, manifesting is performed on a periodic basis, such as daily. The manifest report is delivered to the carrier, which audits the manifest and collects shipping charges.

Steps 408 and 409 are also performed by processing system 119, and entail communicating various data about the returned package.

Step 408 involves receiving and storing merchant business rules, which permit the merchant to specify how packages are to be handled. As explained herein, these rules permit packages to be handled according to any categorization desired by the merchant. For example, the merchant may specify “all shoes go to charity” or “all men's shoes go to charity and all women's shoes go to an outlet”. Returns rule may govern any phase of the returns processing and may be as complex as desired by the merchant. For example, returns rules for notifications may be as simple as a single rule for all returns that specifies “notify merchant”.

Step 409 involves accessing the merchant order associated with the returned package. This step may be used to correlate data from return label 20 (especially scanned data from barcode 25) to additional data about the returned item(s).

Steps 411-414 are performed at a package opening station, and involve “item level” handling. Step 411 is opening the package. Step 412 viewing the order on a display screen, the order having been correlated to the package identifier (already scanned in Step 402 or rescanned in Step 412a) and accessed using processing system 119 in Step 408. Step 414 is identifying the return item in the package.

If desired, an additional step performed at the opening station could be scanning the item itself, for an SKU number or other item information to be added to the data file for the returned item. Opening and identifying returns is made more efficient with the use of scannable barcodes and touch-screens, eliminating the inefficiencies and inaccuracies found in hand-keying.

Step 415 involves communicating return information to the merchant and/or the customer. The communications may be via processing system 119. For example, as explained below, data collected at an opening station may be used to apply a credit to the customer's account with the merchant. The type of information delivered about the return and to whom it is delivered, and when and how delivered, may all be specified in the merchant's business rules.

The data may also be used to send return notification and other return information to the merchant. The data may further be used to notify the customer of receipt of the package, and perhaps also application of credit to the customer's account.

Step 415 may also include signaling to processing system 119 that a credit is due the customer. Step 410 is handling the credit, if called for by merchant rules, and in the manner called for by the rules.

The various options for notifying the customer and/or merchant, the contents of the notice, and the transmittal of tracking data to a tracking system, are all determined by merchant notification rules. These rules may be stored in processing system 119.

Steps 420-422 are performed at a dispositioning station. Step 420 (optional, if the package has been opened in Steps 411-414) is examining the item inside the package. Step 421 is determining the disposition of the item. Data obtained in Step 402 identifies the merchant so that processing system 119 can match stored business rules to the merchant associated with the package. Additional data from the return label may also be read for the purpose of matching rules to the particular package. For example, a certain type of item may be dispositioned according to a specific rule. If desired, data obtained by opening the package may also be used to determine disposition. This data may be based on a visual inspection of the item or a scan of a code with the item, such as an SKU code. This inside-the-package data may be entered into processing system 119 manually or machine read.

Step 421 is performed in accordance with disposition rules provided by the merchant and stored in processing system 119 in Step 409. Items may be dispositioned by factors such as SKU, value, age, or zip. with each of these factors being determined by machine reading data on return label 20 or on labeling on the product inside the package. Step 422 is sorting the item according to its disposition. The various dispositions may include, without limitation, return-to-stock (RTS), return to vendor (RTV), return to sender, send to auction, liquidate, send to outlet, destroy, send to salvage or waste disposal, send to a refurbishing or repair shop, send to charity, or recycle. Various “return to fulfillment” options may be provided in addition to return to vendor.

In other scenarios, the “return dispositioning” might be dispositioning to another customer. An example of this type of service is a rental service, in which a first customer returns an item to be delivered to a next customer.

Steps 430-432 are performed at a staging station. In Step 430, package containers are placed in outbound lanes. In Step 431, the returns provider generates bills of lading. In Step 432, the returns provider notifies the carrier that the container is ready for pickup.

The process described above provides for processing of returns at the item level. That is, the package is opened, sorted, and dispositioned out of the package in which it was returned. Items may be poly-bagged or otherwise re-packaged and labeled according to return rules specified by the merchant and stored in processing system 119. A simpler implementation of the process would eliminate the package opening and examination and sorting at the item level, and packages. would be handled, re-labeled, aggregated at the package level. Steps 412 and 415 may be performed at the package level, if there is no package opening step.

Regardless whether the returns center handles returns at the package level or item level, the returns center is capable of multi-level sorts. As indicated above in connection with FIG. 8, the final sort is typically on the basis of the package's (or item's) final disposition. However, prior to that, sorting can be determined from flag 22 or barcode 25, at any level desired by the merchant. For example, at a product category level, all shoes may be routed to a specialist for examining.

In the example of FIGS. 1 and 8, the services incorporate use of a postage paid return label, such as label 20, which has machine readable coding. However, the methods of FIG. 4 could be easily adapted to postage paid packages, such as by eliminating the manifesting steps.

Rules-Based Returns Processing

In all embodiments of the invention, an important feature is the use of merchant business rules. These rules can specify any aspect of returns handling—sorting, notification, examination, disposition, crediting. The merchant can update or condition the rules as desired. The rules permit the return process to be dynamic, in the sense that they can be changed independently of any tags, codes, or other indicia printed or attached to the package or item being returned. They can be changed after a return label has been printed, which means that they can be changed after an item has been sold and while it is in transit. Barcode 25 and any other indicia with the returned item are used to correlate to the merchant's current set of rules. For example, if shoes are returned when they are out of season, a new business rule can specify that they are to be liquidated rather than returned to stock.

The following table provides a detailed description of the various tasks that may be performed at a returns center, such as the returns center of FIG. 1. Returns with various types of labels, whether in accordance with label 20 or having less or no machine readable data, may be received at the returns center. The level of returns processing (the type and number of the tasks that are performed) is determined by the type of label and the merchant's returns rules. Inbound packages to the returns center can be sorted for value-added services or passed through to dispositioning without additional services.

| | |
|---|---|
| Requirement Name | Description |

Value Added Center, System Setup

| | |
|---|---|
| Support for all return types | System must be able to process packages and items from any inbound source, |
| | including: |
| | Neighborhood return stores |
| | Packaged mailing label |
| | Web-based mailing label |
| | Self-paid Label (e.g., not pre-paid and without bar-code) |
| Value-added or delivery-only | System must support setup of merchant selection for value-added (full- |
| | service) or delivery-only handling |
| Rules-based inbound package | System must support setup of inbound package routing rules. |
| sort | Package rules must support merchant selection |
| | Package rules must support size-based conditions. |
| | Package rules must support weight-based conditions |
| Rules-based Routing/ | System must support setup of merchant item routing/disposition rules. |
| Disposition | Item rules must support value-based conditions. |
| | Item rules must support size-based conditions. |
| | Item rules must support weight-based conditions. |
| | Item rules must support SKU-based conditions. |
| | Item rules must support specification of an item label |
| Rules-based Inventory | System must support setup of Merchant rules controlling Inventory Hold/Delivery |
| Hold/Delivery thresholds | thresholds. |
| | Rules must support volume (trailer load) options. |
| | Rules must support time-limit options. |
| | Rules must support disposition types |
| | Rules must support item category types |
| | Rules must support vendor types |
| Multiple Merchant/RTS | System must support setup of merchant locations, including multiple Return-to-Stock |
| locations | (RTS) locations |
| | Locations are driven by SKUs. |
| 3^{rd} party locations | System must support setup of other delivery locations, including outlets, donation |
| | centers, liquidation tent-sale sites. |
| Rules-based RTV processing | System must support setup of Vendor return processing rules |
| | ability to notify Vendor based on time-based thresholds |
| | ability to notify Vendor based on volume-based thresholds |
| | ability to notify Vendor based on SKU-based thresholds |
| | support for electronic notification methods, including email and fax. |
| Merchant Product ID Setup | System must be able to setup merchant product Ids, by receiving product identifier |
| | data from merchant. |
| Multi-carrier support (inbound) | Ability to support multiple inbound transportation carriers. |
| Multi-carrier support (outbound) | Ability to support multiple outbound transportation carriers. |
| Number of VACs | |

Value-added Center: Receive

| | |
|---|---|
| Scan | Label must be scanned |
| | Merchant label, if bar coded, must be scanned. |
| | Must support scans of multiple merchant bar codes on a single label, in |
| | order to uniquely identify order. |
| | If label is not scanned, package must be identified and recorded in some |
| | other manner. |
| | Scan must record receipt of package, with date recorded as GMT. |
| | Scan must record destination of package, if applicable. |
| | Scan must record full bar code information, up to 64 bits. |
| | Scan must record inbound carrier source. |
| | Scan must record package tracking number, if applicable. |
| | Scan station must support data entry. |
| Damage check | Must examine package for damage. |
| | Criteria should be broad: either “package OK” or “package destroyed” |
| | Default is “package OK” |
| | Results of inspection must be recorded. |
| | Setup must be configurable by facility. |
| Weigh | Each package, regardless of destination, must be weighed. |
| | Package weight must be recorded in the system. |
| | Weight shall be recorded in pounds in four decimal places, accurate to two |
| | decimal places. |
| Inbound Package Sort | Packages must be sorted according to destination (merchant, |
| | warehouse/location). |
| | Damaged packages must be separated and processed separately. |
| | Must permit routing of “pass through” packages without value-added |
| | processing, or “value added” packages. |
| License Plate support | Ability to assign a unique ID to inbound pre-paid packages without a label, |
| | including a merchant ID and facility ID. |
| Multiple barcode support | Ability to record multiple barcodes on inbound package. |

Value-added Center: Identify

| | |
|---|---|
| Opening | Open all packages routed for value-added processing |
| Documentation | Extract documentation from package. |
| Item Identification | Match items to documentation or RMA, if applicable. |
| | Verify that items can be properly identified |
| | Verify that the items match the documentation (paper) |
| | Verify that the items match the documentation (electronic) |
| | Record item identification |
| | Record item return reason |
| | Record item return type (return, exchange or gift) |
| | Record item inspection data, if any |
| | Record item quantity |
| Notification to Merchant | Provide return data to merchant enabling credit notification |
| | Provide item disposition data to merchant |
| | Provide package receipt and tracking notification to merchant |
| | Support for multi-invoice returns |
| | Support for multi-package return |
| | Frequency of notification to merchant |
| Disposition & Destination Sort: | Support for the following Disposition types: |
| RTM only (Rules-based) | RTM (return-to-merchant) |
| | Route item according to Merchant business rules |
| | Record routing of each item |
| | Follow Merchant rules for disposition and destination. |
| | Support for multiple sorts |
| Disposition & Destination Sort: | Support for the following Disposition types: |
| various (Rules-based) | RTS (return-to-stock) |
| | RTV (return-to-vendor) |
| | Outlet |
| | Destroy |
| | Liquidate |
| | Route item according to Merchant business rules |
| | Record routing of each item |
| | Follow Merchant rules for disposition and destination. |
| | Support for multiple sorts |
| Disposition & Destination Sort: | Route item according to Merchant exam |
| various (Exam-based) | RTS (return-to-stock) |
| | RTV (return-to-vendor) |
| | Outlet |
| | Destroy |
| | Liquidate |
| | Record routing of each item |
| | Follow Merchant rules for disposition and destination. |
| | Support for multiple sorts |
| Vendor Return Authorization | Support for vendor return authorization processes |
| Package & Dunnage Removal | Support for removing package and dunnage materials |
| Item labeling | Support production of item labels, based on internal rules |
| Inventory Aggregation & Hold | Collect and store items destined for a common location/destination. |
| | Support at both facility and system levels. |
| Non-deliverables support | Ability to process non-deliverable packages. |
| Poly-bagging support | Ability to support poly-bags for certain disposition types |
| Disposition & Destination Data | Record and transmit data to neighborhood return center |
| Notification | |
| Disposition Management | RTS: support for delabeling items |

Value-added Center: Shipping

| | |
|---|---|
| Container Aggregation | Containerize packages or items for a common destination |
| Package identification | Identify the individual packages in a container |
| Container manifest | Generate a manifest for each container |
| | Record the container manifest in the system |
| | Identify containers destined for a common destination |
| Trailer/truck manifest | Generate a manifest for the trailer/truck |
| | Record the trailer/truck manifest in the system |
| | Record Bill-of-lading (BOL) in the system |
| Exception Handling/Research | Ability to access merchant customer history, including off-file data. |
| | Ability to create new customers in Merchant system |
| | Support for data entry |
| | Ability to identify multiple product attributes |
| | Support for customer change-of-address |
| | Support for the following scenarios: |
| | Cannot identify merchant |
| | Cannot produce an RMA |
| | Cannot identify item |
| | Cannot identify order |
| Re-box, re-kit, re-furbish | Re-package according to merchant fulfillment rules |
| Item labeling (per Merchant | Produce and apply item labels according to merchant rules, with no |
| WMS) | merchant integration |
| Item labeling (per Merchant | Produce and apply item labels according to merchant rules, with merchant |
| WMS) | integration |
| Forward Fulfillment | Provide forward fulfillment capabilities, including: |
| | integration with merchant order management system |
| | re-packaging, re-labeling as needed |
| | record and transmit data to processing center. |
| Aging | Support for merchant driven inventory-aging rules. |
| Proof of destruction | Support for merchant and/or vendor approved proof of destruction |
| | services. |
| Liquidation service | Support for value-added liquidation services. |
| Vendor inspection | Support for vendor inspection. |

Value-added Center: Carrier

| | |
|---|---|
| Final Ship Notification | Record and transmit the following: |
| | Delivery confirmation |
| Notification tracking | Ability to tracking notification information via a web site |

Value-added Center: Data Communications

| | |
|---|---|
| Neighborhood return center | Transmit recorded data to processing center |
| Integration | Frequency of data transmission is daily (end-of-day) at minimum |
| Package-level details | Record and transmit the following data for each package |
| | Date and time received (GMT) |
| | Date and time shipped (GMT) |
| | Merchant |
| | Package identifier |
| | Package carrier source (e.g., FedEx, USPS) |
| | Package weight |
| | Package destination |
| | Package bar code |
| | Package condition |
| | Package routing, if applicable (e.g., facility to facility) |
| | Type of service, including “value-add” or “pass-through” |
| Item-level details | Record and transmit the following data for each item: |
| | Date and time scanned |
| | Item identifier |
| | Order line number/identifier |
| | Item matches documentation flag |
| | Disposition |
| | Destination |
| | Return reason |
| | Return type |
| | Sort or slot, if applicable |
| | Pallet ID, if applicable |
| | Container ID, if applicable |
| Outbound Manifests Bills of | Provide bills of lading for each pallet/container |
| Lading/Manifests | Provide bills of lading for each truck/trailer load |
| | Bill of lading must identify packages, for “pass-through” customers |
| | Bill of lading must identify items, for “value add” customers |
| | Each bill of lading shall be transmitted to processing center |
| | Transmission shall take place no more than 24 hours after shipment |
| Vendor RA Notification | Support for electronic notification, including smtp, ftp, fax and/or Interactive |
| | Voice Response (IVR) system. |
| | Configurable by vendor and/or merchant. |
| Final Ship Notification | Record and transmit the following: |
| | Pickup notification |
| | Pickup confirmation |
| Billing Support | Record and transmit all data required to bill partners and merchants. |
| Carrier Manifest Support | Support for reporting and sampling necessary to fulfill Manifest |
| | requirements. |

Priority Mail Support

| | |
|---|---|
| Capture in PacSys if a package | During the scanning and weighing process, must capture if a package was sent |
| was sent Priority Mail | by a consumer using the USPS Priority Mail service. This capability is |
| | configurable by merchant, and optional depending on merchant rules (similar to |
| | a balloon flag) |
| Pass Priority Mail notification to | For each Priority Mail package scanned at the warehouse facility, the system |
| ReturnValet | must pass the appropriate notification to ReturnValet. |
| | Must be included in both the 221 CSV transmission and the nightly FTP file |
| Capture if a package was sent | The system must accept notification from the carrier if a package was sent using |
| using Priority Mail | Priority Mail. |
| Configure the electronic | The electronic manifest must be able to include or remove Priority Mail packages |
| manifest to act upon the Priority | from the postal billing calculation. |
| Mail notification | |
| Rate Priority Mail packages | The system must use the Priority Mail notification to correctly assess postage for |
| within the manifesting process | all Priority Mail packages. |
| Remove Priority Mail packages | The system must remove all packages identified as being sent Priority Mail |
| from electronic manifest | before the electronic manifest is created. |
| document | |

What is claimed is:

1. A method, performed by a returns provider, of handling customer returns of items on behalf of multiple merchants, comprising the steps of:
storing a set of item merchant returns rules in a processing system, such that a set of returns rules is associated with each merchant,
receiving packages containing returned items at one or more returns centers;
wherein affixed to each package is a printed label, the label having machine readable data representing at least the identification of a merchant associated with the returned item;
scanning the machine readable data on each package;
correlating at least a portion of the machine readable data with a set of returns rules; and
differentiating packages for further disposition, based on the results of the correlating step.

2. The method of claim 1, wherein the method is performed by one of a number of returns centers, and at the returns center closest to the customer.

3. The method of claim 1, wherein the machine readable data identifies at least a purchase transaction.

4. The method of claim 3, wherein the purchase transaction is represented by an invoice number.

5. The method of claim 3, wherein the purchase transaction is represented by a customer number.

6. The method of claim 3, wherein the purchase transaction is represented by a product number.

7. The method of claim 1, wherein the machine readable label further has data representing the package origin and package delivery location, and further comprising the steps of weighing the package and using the processing system to assess shipping charges.

8. The method of claim 1, further comprising the step of notifying the customer of receipt of the return.

9. The method of claim 1, further comprising the step of notifying the merchant of the return.

10. The method of claim 1, further comprising the step of using the processing system to display order data associated with the package during the correlating step.

11. The method of claim 1, wherein the differentiating step is accomplished by labeling packages with a disposition indicator.

12. The method of claim 1, wherein the differentiating step is accomplished by sorting packages for disposition.

13. The method of claim 1, wherein the differentiating step is performed by sorting packages in accordance with one or more of the following categories: return-to-stock (RTS), return to vendor (RTV), liquidate, send to outlet, destroy, send to salvage or waste disposal, send to a refurbishing or repair shop, send to charity, recycle, auction, or return to sender.

14. The method of claim 12, further comprising additional sorting steps, based on the correlating step.

15. The method of claim 1, wherein the package is further labeled with a human readable code, and further comprising the step of correlating the code with a set of returns rules.

16. The method of claim 1, further comprising the step of opening the package, and wherein the differentiating step is performed after the opening step.

17. The method of claim 16, further comprising at least one additional correlating step after the opening step, and at least one additional differentiating step based on the additional correlating step.

18. A method, performed by a returns provider, of handling customer returns of items on behalf of multiple merchants, comprising the steps of:
storing a set of item merchant returns rules in a processing system, such that a set of returns rules is associated with each merchant,
receiving packages containing returned items at a returns center;
wherein affixed to each package is a printed label, the label having machine readable data representing at least the identification of a merchant associated with the returned item;
scanning the machine readable data on each package;
correlating at least a portion of the machine readable data with a set of returns rules;
opening the package to reveal the item;
scanning item-level machine readable data associated with the item;
correlating the item-level machine readable data with the set of returns rules; and
differentiating packages for further disposition, based on the results of at least one of the correlating steps.

19. The method of claim 18, further comprising the step of re-packaging items after the differentiating step.

20. The method of claim 1, further comprising the step of re-labeling the re-packaged items.

21. A system for handling customer returns of items on behalf of multiple merchants, the returns being made by customers in packages having machine readable labels, comprising:
a number of return centers, having at least a scanning station for scanning the machine readable label; a sorting station for sorting the packages; and an examination station for determining the final disposition of the item; and
a processing system for storing return rules from each merchant, for receiving the machine readable data from the scanning station, for linking the package identification with the rules of a particular merchant, and for transmitting return rules for display at one or more of the return center stations;
wherein the return rules specify at least how the package is to be dispositioned.

22. The system of claim 21, wherein the scanning station is further operable to weigh the packages, and wherein the processing system is further operable to assess shipping charges for the packages.

23. The system of claim 21, further comprising an opening station for opening packages and examining the contents.

24. The system of claim 21, wherein the returns rules specify package disposition in accordance with one or more of the following categories: return-to-stock (RTS), return to vendor (RTV), liquidate, send to outlet, destroy, send to salvage or waste disposal, send to a refurbishing or repair shop, send to charity, recycle, return to sender, or auction.

25. A merchandise return computer system, comprising:
at least one client system programmed to acquire machine readable return label data, the return label data containing at least merchant identification data; and
a rules processing system programmed to receive the return label data from the client system, to access the a set of merchant return rules, and to match return rules to return data, and to deliver at least one rule to the client system.

26. The system of claim 25, further comprising a rules database for storing the merchant return rules, the merchant return rules having at least one disposition rule for determining the disposition of returned items.

27. The system of claim 26, wherein the returns rules specify package disposition in accordance with one or more of the following categories: return-to-stock (RTS), return to vendor (RTV), liquidate, send to outlet, destroy, send to salvage or waste disposal, send to a refurbishing or repair shop, send to charity, or recycle.

28. The system of claim 25, wherein the return label data further contains transaction data, and wherein the central processing system is further programmed to match transaction data to return rules.

29. A merchandise return computer system for enabling a customer to return a package containing one or more items previously acquired from a merchant during a unique transition, the system comprising:
a label generating process for generating return labels, the label containing a shipping destination and integrated machine readable data representing at least a shipping origin of the package and identification of a merchant.

30. The system of claim 29, wherein the machine readable data further represents the transaction.

31. The system of claim 29, wherein the label generating process generates labels to be included with a shipment of one or more items to the customer.

32. The system of claim 29, wherein the label generating process generates labels to be delivered in electronic form to the customer.

33. The system of claim 32, wherein the label is to be downloaded via the Internet.

34. The system of claim 32, wherein the label is to be emailed to the customer.

35. The system of claim 32, wherein the label is to be faxed to the customer.

36. The system of claim 29, further comprising a label reading process for reading the machine readable data and for matching the machine readable data to stored business rules of a merchant.

37. A computer storage medium containing programming, the programming operable to:
generate return labels, the label containing a shipping destination and integrated machine readable data representing at least a shipping origin of the package and identification of a merchant.

38. The system of claim 37, wherein the machine readable data further represents the transaction.

39. The system of claim 37, wherein the label generating process generates labels to be included with a shipment of one or more items to the customer.

40. The system of claim 37, wherein the label generating process generates labels to be delivered in electronic form to the customer.

41. The system of claim 40, wherein the label is to be downloaded via the Internet.

42. The system of claim 40, wherein the label is to be emailed to the customer.

43. The system of claim 40, wherein the label is to be faxed to the customer.

44. The system of claim 37, further comprising a label reading process for reading the machine readable data and for matching the machine readable data to stored business rules of a merchant.

45. A computer storage medium containing programming, the programming operable to:
acquire machine readable return label data, the return label data containing at least merchant identification data; to access a set of merchant return rules, and to match the return rules to the return data.
